(19) United States
(12) Patent Application Publication
(10) Pub. No.: US 2020/0097615 A1
(43) Pub. Date: Mar. 26, 2020

(54) DIFFERENCE-BASED COMPARISONS IN LOG-STRUCTURED GRAPH DATABASES

(71) Applicant: Microsoft Technology Licensing, LLC, Redmond, WA (US)

(72) Inventors: Yongling Song, Dublin, CA (US); Scott M. Meyer, Berkeley, CA (US); Shenoda Guirguis, San Jose, CA (US); Manu Dhundi, Sunnyvale, CA (US); Matus Faro, Sunnyvale, CA (US); Ionut Constandache, Sunnyvale, CA (US); Yiming Yang, Fremont, CA (US)

(73) Assignee: Microsoft Technology Licensing, LLC, Redmond, WA (US)

(21) Appl. No.: 16/136,909

(22) Filed: Sep. 20, 2018

(51) Int. Cl. G06F 17/30

(52) U.S. Cl. CPC G06F 17/30958; G06F 17/30292; G06F 9/54; G06F 17/30303; G06F 17/30595

(57) ABSTRACT

The disclosed embodiments provide a system for performing difference-based comparisons in log-structured graph databases. During operation, the system performs a first write of a first set of graph data to a first log-structured graph database followed by a second write of a second set of graph data to the first log-structured graph database to determine a first difference between the two sets of graph data. Next, the system performs a third write of the second set of graph data to a second log-structured graph database followed by a fourth write of the first set of graph data to the second log-structured graph database to determine a second difference between the two sets of graph data. The system then determines, based on the differences, a comparison result containing a set-based relationship between the two sets of graph data. Finally, the system outputs the comparison result.

### RELATED APPLICATION

The subject matter of this application is related to the subject matter in a co-pending non-provisional application entitled “Edge Store Designs for Graph Databases,” having Ser. No. 15/360,605 and filing date 23 Nov. 2016 (Attorney Docket No. LI-900847-US-NP).

### BACKGROUND

### Field

The disclosed embodiments relate to graph databases. More specifically, the disclosed embodiments relate to techniques for performing difference-based comparisons in log-structured graph databases.

### Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of the results or joining the results. In general, by leveraging knowledge of the underlying relational model, the set of queries can be identified and then performed in an optimal manner

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner This can degrade performance and the user experience when using applications.

Various approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers (i.e., in a manner consistent with the application's perspective). However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for performing difference-based comparisons in a log-structured graph database in accordance with the disclosed embodiments.

FIG. 4 shows a flowchart illustrating a process of performing difference-based comparisons in a log-structured graph database in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing difference-based comparisons in log-structured graph databases. A log-structured graph database may store a graph containing nodes, edges between the nodes, and predicates describing the nodes and/or edges in an append-only log. The log-structured graph database may also omit duplication of elements of the graph in the log. Thus, a node, edge, predicate, and/or other element of the graph that has already been added to the log will not be rewritten at a subsequent point in the log.

A series of writes to the log-structured graph database may be used to identify differences and/or set-based relationships between two sets of graph data. The series of writes may include a first write of a first set of graph data to a first graph database, followed by a second write of a second set of graph data to the first graph database. The series of writes may also include a third write of the second set of graph data to a second graph database, followed by a fourth write of the first set of graph data to the second graph database.

Changes made to each graph database from one write to the next may then be used to identify differences between the first and second sets of graph data. A first difference between the two sets of graph data may include changes to the first graph database between the first and second writes, and a second difference between the two sets of graph data may include changes to the second graph database between the third and fourth writes.

The differences may then be analyzed to determine a set-based relationship between the two sets of graph data. When both differences are empty, the sets of graph data are identical. When the first difference is empty and the second difference is non-empty, the first set of graph data is a superset of the second set of graph data. When the first difference is non-empty and the second difference is empty, the second set of graph data is a superset of the first set of graph data. When both differences are non-empty, neither set of graph data is a superset of the other (i.e., each set of graph data contains records that are not found in the other set).

The set-based relationship may then be outputted in a comparison result for the two sets of graph data. For example, the comparison result may be displayed within a tool for validating or verifying one set of graph data using the other set of graph data. The comparison result may also include the differences and/or an edit distance between the two sets of data.

The disclosed embodiments may thus leverage existing graph database operations and structures to detect and characterize differences between sets of graph data. Such differences may further be used to validate the graph data and/or detect problems with replicating the graph data across multiple data sources and/or processing of queries related to the graph data. Consequently, the disclosed embodiments may improve applications, computer systems, and/or technologies related to processing queries of graph data, replicating data across multiple sources, and/or validating data sets.

### Difference-Based Comparisons in Log-Structured Graph Databases

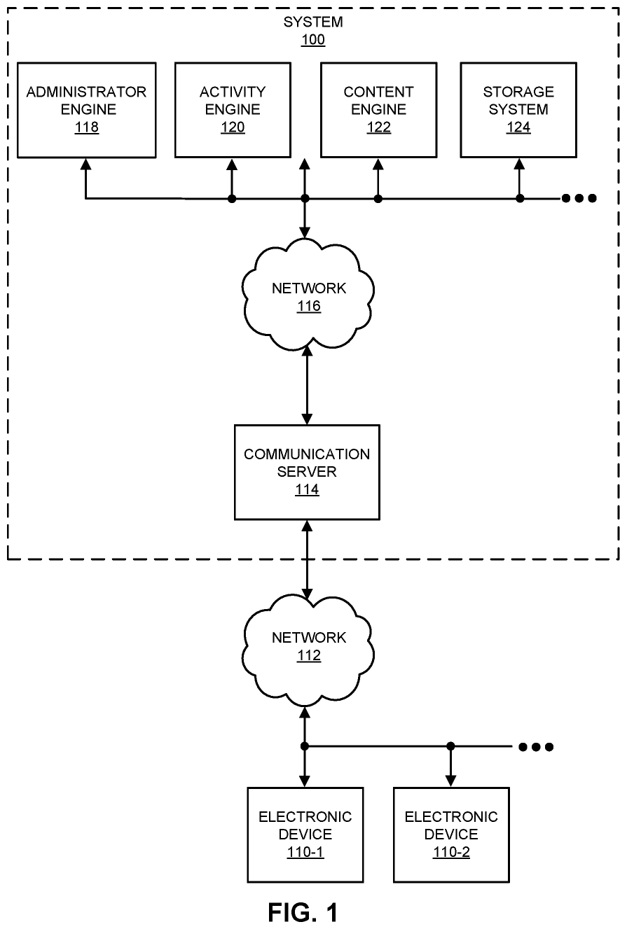

FIG. 1 presents a schematic of a system 100 that performs a graph-storage technique. In system 100, users of electronic devices 110 may use a service that is provided, at least in part, using one or more software products or applications executing in system 100. As described further below, the applications may be executed by engines in system 100.

Moreover, the service may be provided, at least in part, using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, an online network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the online network. For example, administrator engine 118 may handle user accounts and user profiles, activity engine 120 may track and aggregate user behaviors over time in the online network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices (e.g., a large-scale distributed storage system).

Note that each of the users of the online network may have an associated user profile that includes personal and professional characteristics and experiences, which are sometimes collectively referred to as ‘attributes’ or ‘characteristics.’ For example, a user profile may include demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the online network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the online network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the online network.

To address these problems, storage system 124 includes a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

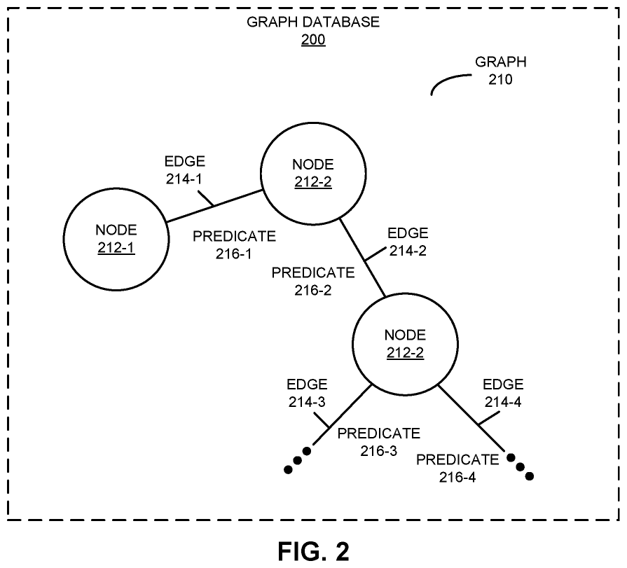

FIG. 2 presents a block diagram illustrating a graph 210 stored in a graph database 200 in system 100 (FIG. 1). Graph 210 includes nodes 212, edges 214 between nodes 212, and predicates 216 (which are primary keys that specify or label edges 214) to represent and store the data with index-free adjacency, so that each node 212 in graph 210 includes a direct edge to its adjacent nodes without using an index lookup.

Note that graph database 200 may be an implementation of a relational model with constant-time navigation (i.e., independent of the size N), as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that maintains the structure (i.e., nodes, edges) of the subset of graph 210.

The graph-storage technique may include methods that allow the data associated with the applications and/or the online network to be efficiently stored and retrieved from graph database 200. Such methods are described in U.S. Pat. No. 9,535,963 (issued 3 Jan. 2017), entitled “Graph-Based Queries,” which is incorporated herein by reference.

Referring back to FIG. 1, the graph-storage techniques described herein may allow system 100 to efficiently and quickly (e.g., optimally) store and retrieve data associated with the applications and the online network without requiring the applications to have knowledge of a relational model implemented in graph database 200. Consequently, the graph-storage techniques may provide technological improvements in the availability and the performance or functioning of the applications, the online network and system 100, which may reduce user frustration and which may improve the user experience. The graph-storage techniques may additionally increase engagement with or use of the online network, and thus may increase the revenue of a provider of the online network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

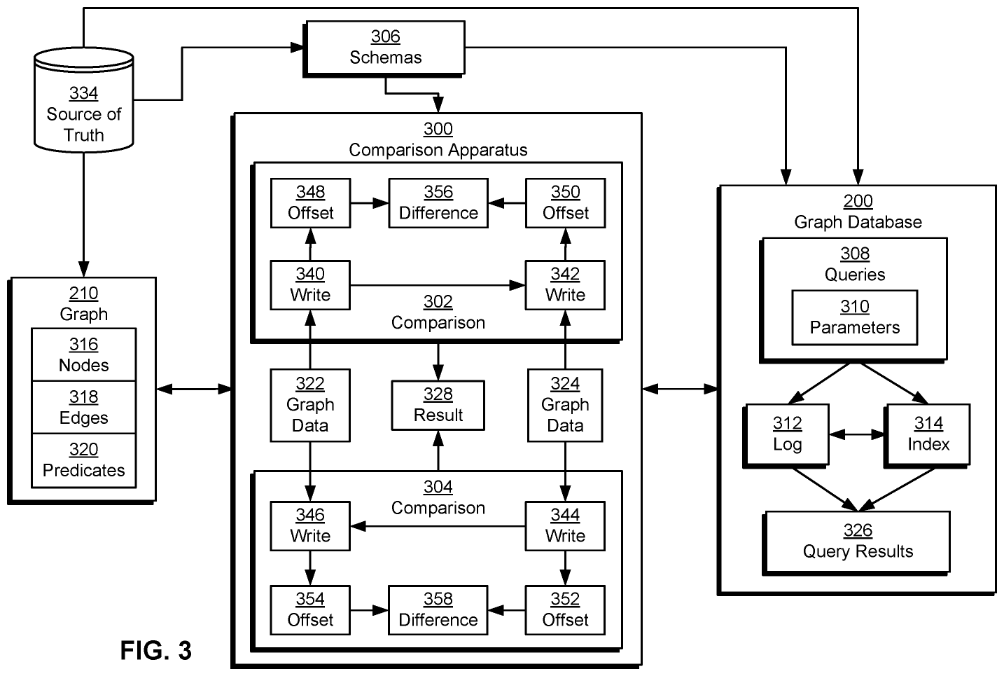

As shown in FIG. 3, graph 210 and one or more schemas 306 associated with graph 210 are obtained from a source of truth 334 for graph database 200. For example, graph 210 and schemas 306 may be retrieved from a relational database, distributed filesystem, and/or other storage mechanism providing the source of truth.

As mentioned above, graph 210 includes a set of nodes 316, a set of edges 318 between pairs of nodes, and a set of predicates 320 describing the nodes and/or edges. Each edge in graph 210 may be specified in a (subject, predicate, object) triple. For example, an edge denoting a connection between two members named “Alice” and “Bob” may be specified using the following statement:
Edge(“Alice”, “ConnectedTo”, “Bob”).
   In the above statement, “Alice” is the subject, “Bob” is the object, and “ConnectedTo” is the predicate. A period following the “Edge” statement may denote an assertion that is used to write the edge to graph database 200. Conversely, the period may be replaced with a question mark to read any edges that match the subject, predicate, and object from the graph database:
Edge(“Alice”, “ConnectedTo”, “Bob”)?
   Moreover, a subsequent statement may modify the initial statement with a tilde to indicate deletion of the edge from graph database 200:
Edge˜(“Alice”, “ConnectedTo”, “Bob”).

In addition, specific types of edges and/or complex relationships in graph 210 may be defined using schemas 306. Continuing with the previous example, a schema for employment of a member at a position within a company may be defined using the following:
DefPred(“employ/company”, “1”, “node”, “0”, “node”).
DefPred(“employ/member”, “1”, “node”, “0”, “node”).
DefPred(“employ/start”, “1”, “node”, “0”, “date”).
DefPred(“employ/end_date”, “1”, “node”, “0”, “date”).
M2C@(e, memberId, companyId, start, end):
   Edge(e, “employ/member”, memberId),
   Edge(e, “employ/company”, companyId),
   Edge(e, “employ/start”, start),
   Edge(e, “employ/end_date”, end)

In the above schema, a compound structure for the employment is denoted by the “@” symbol and has a compound type of “M2C.” The compound is represented by four predicates and followed by a rule with four edges that use the predicates. The predicates include a first predicate representing the employment at the company (e.g., “employ/company”), a second predicate representing employment of the member (e.g., “employ/member”), a third predicate representing a start date of the employment (e.g., “employ/start”), and a fourth predicate representing an end date of the employment (e.g., “employ/end_date”). Each predicate is defined using a corresponding “DefPred” call; the first argument to the call represents the name of the predicate, the second argument of the call represents the cardinality of the subject associated with the edge, the third argument of the call represents the type of subject associated with the edge, the fourth argument represents the cardinality of the object associated with the edge, and the fifth argument represents the type of object associated with the edge.

In the rule, the first edge uses the second predicate to specify employment of a member represented by “memberId,” and the second edge uses the first predicate to specify employment at a company represented by “companyId.” The third edge of the rule uses the third predicate to specify a “start” date of the employment, and the fourth edge of the rule uses the fourth predicate to specify an “end” date of the employment. All four edges share a common subject denoted by “e,” which functions as a hub node that links the edges to form the compound relationship.

In another example, a compound relationship representing endorsement of a skill in an online professional network may include the following schema:
DefPred(“endorser”, “1”, “node”, “0”, “node”).
DefPred(“endorsee”, “1”, “node”, “0”, “node”).
DefPred(“skill”, “1”, “node”, “0”, “node”).
Endorsement@(h, Endorser, Endorsee, Skill):
   Edge(h, “endorser”, Endorser),
   Edge(h, “endorsee”, Endorsee),
   Edge(h, “skill”, Skill).

In the above schema, the compound relationship is declared using the “@” symbol and specifies “Endorsement” as a compound type (i.e., data type) for the compound relationship. The compound relationship is represented by three predicates defined as “endorser,” “endorsee,” and “skill.” The “endorser” predicate may represent a member making the endorsement, the “endorsee” predicate may represent a member receiving the endorsement, and the “skill” predicate may represent the skill for which the endorsement is given. The declaration is followed by a rule that maps the three predicates to three edges. The first edge uses the first predicate to identify the endorser as the value specified in an “Endorser” parameter, the second edge uses the second predicate to identify the endorsee as the value specified in an “Endorsee” parameter, and the third edge uses the third predicate to specify the skill as the value specified in a “Skill” parameter. All three edges share a common subject denoted by “h,” which functions as a hub node that links the edges to form the compound relationship. Consequently, the schema may declare a trinary relationship for an “Endorsement” compound type, with the relationship defined by identity-giving attributes with types of “endorser,” “endorsee,” and “skill” and values attached to the corresponding predicates.

Compounds stored in graph database 200 may model complex relationships (e.g., employment of a member at a position within a company) using a set of basic types (i.e., binary edges 318) in graph database 200. More specifically, each compound may represent an n-ary relationship in graph 210, with each “component” of the relationship identified using the predicate and object (or subject) of an edge. A set of “n” edges that model the relationship may then be linked to the compound using a common subject (or object) that is set to a hub node representing the compound. In turn, new compounds may dynamically be added to graph database 200 without changing the basic types used in graph database 200, by specifying relationships that relate the compound structures to the basic types in schemas 306.

Graph 210 and schemas 306 are used to populate graph database 200 for processing queries 308 against the graph. More specifically, a representation of nodes 316, edges 318, and predicates 320 may be obtained from source of truth 334 and stored in a log 312 in the graph database. Lock-free access to graph database 200 may be implemented by appending changes to graph 210 to the end of the log instead of requiring modification of existing records in source of truth 334. In turn, graph database 200 may provide an in-memory cache of log 312 and an index 314 for efficient and/or flexible querying of the graph.

Nodes 316, edges 318, and predicates 320 may be stored as offsets in log 312. For example, the exemplary edge statement for creating a connection between two members named “Alice” and “Bob” may be stored in a binary log 312 using the following format:
256 Alice
261 Bob
264 ConnectedTo
275 (256, 264, 261)
   In the above format, each entry in the log is prefaced by a numeric (e.g., integer) offset representing the number of bytes separating the entry from the beginning of the log. The first entry of “Alice” has an offset of 256, the second entry of “Bob” has an offset of 261, and the third entry of “ConnectedTo” has an offset of 264. The fourth entry has an offset of 275 and stores the connection between “Alice” and “Bob” as the offsets of the previous three entries in the order in which the corresponding fields are specified in the statement used to create the connection (i.e., Edge(“Alice”, “ConnectedTo”, “Bob”)).

Because the ordering of changes to graph 210 is preserved in log 312, offsets in log 312 may be used as representations of virtual time in graph 210. More specifically, each offset may represent a different virtual time in graph 210, and changes in the log up to the offset may be used to establish a state of graph 210 at the virtual time. For example, the sequence of changes from the beginning of log 312 up to a given offset that is greater than 0 may be applied, in the order in which the changes were written, to construct a representation of graph 210 at the virtual time represented by the offset.

Graph database 200 may further omit duplication of nodes 316, edges 318, and predicates 320 of graph 210 in log 312. Thus, a node, edge, predicate, and/or other element of graph 210 that has already been added to log 312 will not be rewritten at a subsequent point in log 312.

Graph database 200 also includes an in-memory index 314 that enables efficient lookup of edges 318 by subject, predicate, object, and/or other keys or parameters 310. The index structure may include a hash map and an edge store. Entries in the hash map may be accessed using keys such as subjects, predicates, and/or objects that partially define edges in the graph. In turn, the entries may include offsets into the edge store that are used to resolve and/or retrieve the corresponding edges. Edge store designs for graph database indexes are described in a co-pending non-provisional application entitled “Edge Store Designs for Graph Databases,” having Ser. No. 15/360,605, and filing date 23 Nov. 2016 (Attorney Docket No. LI-900847-US-NP), which is incorporated herein by reference.

The system of FIG. 3 additionally includes a comparison apparatus 300 that performs difference-based comparisons of graph data 322-324 from a representation of graph 210 in source of truth 334, graph database 200, and/or another source. For example, comparison apparatus 300 may verify that data stored in log 312 and/or index 314 of graph database 200 is consistent with source of truth 334, a replica of graph database 200, a different version of graph database 200, and/or another copy of the data. In another example, comparison apparatus 300 may validate that query results 326 from a query executed on graph database 200 match corresponding query results from source of truth 334, a different version of graph database 200, and/or an application programming interface (API) for accessing a copy of graph 210. In a third example, comparison apparatus 300 may confirm that two different versions of the same graph database query (e.g., a query for a compound relationship and a different query for edges modeling the compound relationship) return the same results.

In general, comparison apparatus 300 may be used to compare two or more sets of graph data 322-324 that are obtained from different sources and/or via different retrieval mechanisms. Moreover, graph data 322-324 may include all nodes 316, edges 318, and/or predicates 320 in graph 210, or graph data 322-324 may include one or more sub-graphs of graph 210.

Graph data 322-324 may additionally be obtained in different formats. For example, each set of graph data 322-324 may include a binary graph image that can be loaded into graph database 200; a graph log format used to store data in log 312; a serialization format such as AVRO, JavaScript Object Notation (JSON), Extensible Markup Language (XML), and/or HyperText Markup Language (HTML); one or more database records; data from a spreadsheet, document, and/or text file; and/or another representation of nodes 316, edges 318, and/or predicates 320 in graph 210.

In one or more embodiments, comparison apparatus 300 performs comparisons 302-304 of graph data 322-324 using a series of writes 340-346 of graph data 322-324 to graph database 200. For example, comparison apparatus 300 may issue queries 308 to graph database 200 to perform the corresponding writes 340-346 of graph data 322-324 during comparisons 302-304. One comparison 302 includes performing a first write 340 of graph data 322 to an empty copy of graph database 200, followed by a second write 342 of graph data 324 to the same copy of graph database 200. Another comparison 304 includes performing a first write 344 of graph data 324 to an empty copy of graph database 200, followed by a second write 346 of graph data 322 to the same copy of graph database 200. In other words, one set of graph data is initially written to an empty graph database, followed by the other set of graph data; the process is then repeated by writing the two sets of graph data in the opposite order to a different empty graph database.

Because only new nodes 316, edges 318, and predicates 320 are added to log 312 and/or index 314 of a given graph database 200, comparison apparatus 302 can use pairs of sequential writes 340-342 and 344-346 of graph data 322-324 to detect and characterize differences 356-358 between the two sets of graph data 322-234. During comparison 302, comparison apparatus 300 may obtain an offset 348 representing a state of one graph database after write 340 of graph data 322 is made, as well as another offset 350 representing a subsequent state of the graph database after write 342 of graph data 324 is made. During comparison 304, comparison apparatus 300 may obtain an offset 352 representing a state of another graph database after write 344 of graph data 324 is made, as well as another offset 354 representing a subsequent state of the graph database after write 346 of graph data 322 is made.

As discussed above, offsets 348-354 may be obtained from log 312 in the corresponding graph database as representations of virtual time and/or state in the graph database. As a result, comparison apparatus 300 may use changes between offsets 348-350 in one graph database to determine one type of difference 356 between graph data 322 and graph data 324, and comparison apparatus 300 may use changes between offsets 352-354 in another graph database to determine another type of difference 358 between graph data 322 and graph data 324. More specifically, records added between offset 348 and offset 350 in log 312 may indicate that graph data 324 contains nodes 316, edges 318, predicates 320, and/or other graph components that are missing in graph data 322. Similarly, records added between offset 352 and offset 354 in log 312 may indicate that graph data 322 contains nodes 316, edges 318, predicates 320, and/or other graph components that are missing in graph data 324.

Comparison apparatus 300 also uses differences 356-358 identified in comparisons 302-304 to produce a result 328 that includes a set-based relationship between the two sets of graph data 322-324. When both differences 356-358 are empty (i.e., offsets 348 and 350 are the same and offsets 352 and 354 are the same), result 328 may indicate that the two sets of graph data 322-324 are identical. When difference 356 is empty and difference 358 is non-empty (i.e., offsets 348 and 350 are the same but offsets 352 and 354 are different), result 328 may indicate that graph data 322 is a superset of graph data 324. When difference 356 is non-empty and difference 358 is empty (i.e., offsets 348 and 350 are different and offsets 352 and 354 are the same), result 328 may indicate that graph data 324 is a superset of graph data 322. When both differences 356-358 are non-empty (i.e., offsets 348 and 350 are different and offsets 352 and 354 are different), result 328 may indicate that neither set of graph data is a superset of the other.

Comparison apparatus 300 may output result 328 for use in verifying one or both sets of graph data 322-324. For example, comparison apparatus 300 may include result 328 in a user interface, notification, alert, message, log entry, file, database record, and/or other type of human-readable form.

Comparison apparatus 300 may also output, within or along with result 328, differences 356-358 that led to result 328. For example, comparison apparatus 300 may include, in the outputted result 328, nodes 316, edges 318, predicates 320, and/or other records added between offsets 348 and 350 and between offsets 352 and 354. A user may examine the outputted differences 356-358 to identify and/or remedy bugs, anomalies, and/or root causes that resulted in non-empty differences 356-358. Alternatively, the user may use differences 356-358 to verify that one set of graph data correctly contains records that are not found in the other set of graph data (e.g., when one set of graph data is meant to be a superset of the other set of graph data and/or different from the other set of graph data).

Comparison apparatus 300 may perform additional processing related to result 328 and/or differences 356-358. First, comparison apparatus 300 may combine differences 356-358 into an edit distance between the two sets of graph data 322-324. For example, comparison apparatus 300 may sum the number of records in differences 356-358 and/or divide the sum by the total number of records in one or both sets of graph data 322-324 to calculate the edit distance. Comparison apparatus 300 may then include the edit distance in result 328 and/or output the edit distance separately from result 328.

Second, comparison apparatus 300 may use differences 356-358 to assess the quality or consistency of a first set of graph data with respect to another baseline set of graph data. For example, comparison apparatus 300 may characterize differences 356-358 between the first set of graph data and the baseline set of graph data as insertions of records to the baseline set, deletions of records from the baseline set, and/or substitutions of records in the baseline set. Comparison apparatus 300 may also assign a weight to each difference based on the type of the difference (e.g., an addition has a lower weight than a deletion) and/or the type of data affected by the difference (e.g., a missing connection between two people in the same industry is weighted less than a missing connection between two people in different industries). Comparison apparatus 300 may then combine differences 356-358 with the corresponding weights into a single metric characterizing the quality or consistency of the first set of graph data with respect to the baseline set. Finally, comparison apparatus 300 may output the metric as part of result 328 and/or along with result 328.

The system of FIG. 3 may thus leverage existing graph database operations and structures to detect and characterize differences between sets of graph data. Such differences may further be used to validate the graph data and/or detect problems with replicating the graph data across multiple data sources and/or processing queries related to the graph data. Consequently, the disclosed embodiments may improve applications, computer systems, and/or technologies related to processing queries of graph data, replicating data across multiple sources, and/or validating data sets.

Those skilled in the art will appreciate that the system of FIG. 3 may be implemented in a variety of ways. First, comparison apparatus 300, graph database 200, and/or source of truth 334 may be provided by a single physical machine, multiple computer systems, one or more virtual machines, a grid, one or more databases, one or more filesystems, and/or a cloud computing system. Comparison apparatus 300, graph database 200, and/or source of truth 334 may additionally be implemented together and/or separately by one or more hardware and/or software components and/or layers. For example, comparison apparatus 300 may be implemented as a tool that operates within and/or with graph database 200 and/or one or more APIs for accessing graph database 200. The tool may be accessed using a command-line interface (CLI), graphical user interface (GUI), and/or other type of user interface. In another example, comparison apparatus 300 may form a part of a data-audit system that periodically verifies the replication of graph data 322-324 across multiple data sources such as graph databases, relational databases, data centers, collocation centers, and/or other data sources.

Second, the functionality of the system may be used with other types of databases and/or data. For example, comparison apparatus 300 may be configured to verify data sets in other systems that support flexible schemas and/or querying of log-based data structures.

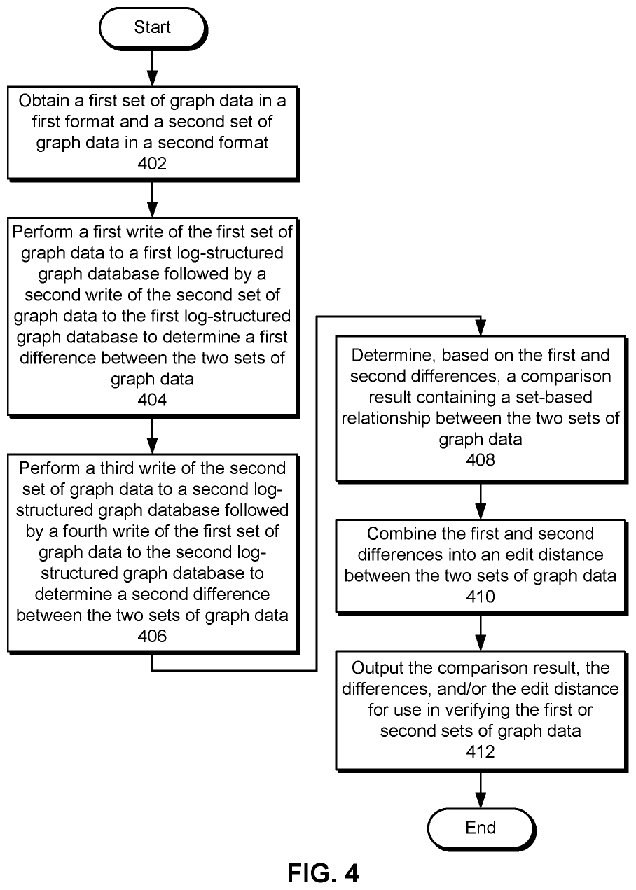

FIG. 4 shows a flowchart illustrating a process of performing difference-based comparisons in a log-structured graph database in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a first set of graph data in a first format and a second set of graph data in a second format are obtained (operation 402). For example, the first and second sets of graph data may be obtained as binary graph images, graph log formats, serialization formats, database records, documents, and/or other types of data. Each set of graph data may also, or instead, be obtained from a different source and/or via a different retrieval mechanism. For example, the two sets of graph data may be obtained from different graph databases, multiple graph database versions, different copies or replicas of a graph database, and/or a source of truth for a graph database. In another example, the two sets of graph data may be obtained using different queries of the same graph database and/or queries of different APIs for accessing the graph database.

Next, a first write of the first set of graph data to a first log-structured graph database followed by a second write of a second set of graph data to the first log-structured graph database are performed to determine a first difference between the two sets of graph data (operation 404). A third write of the second set of graph data to a second log-structured graph database followed by a fourth write of the first set of graph data to the second log-structured graph database are also performed to determine a second difference between the two sets of graph data (operation 406).

During a write of one set of graph data to a given log-structured graph database, each entry from the graph data is added to the log-structured graph database. When the same entry is found in the other set of graph data during the subsequent write of the other set of graph data to the same log-structured graph database, addition of the duplicate entry to the log-structured graph database is omitted. After each write is performed, an offset representing the state of the corresponding log-structured graph database is identified, and a difference between the two sets of graph data is determined based on the two offsets of the pair of writes to the corresponding log-structured graph database. As a result, the two sets of graph data may be identified to be different when a first offset obtained after one set of graph data is written to an empty graph database is different from a second offset obtained after the other set of graph data is subsequently written to the same graph database.

A comparison result containing a set-based difference between the two sets of graph data is then determined based on the first and second differences (operation 408). First, the comparison result may specify that the first and second sets of graph data are identical when the first and second differences are empty. Second, the comparison result may specify that the first set of graph data is a superset of the second set of graph data when the first difference is empty and the second difference is non-empty. Third, the comparison result may specify that the second set of graph data is a superset of the first set of graph data when the first difference is non-empty and the second set difference is empty. Fourth, the comparison result may specify that neither of the first and second sets of graph data is a superset of the other when the first and second differences are non-empty.

The first and second differences are also combined into an edit distance between the two sets of graph data (operation 410). For example, the first and second differences may be summed to obtain a representation of the edit distance. The sum may optionally be divided by the total number of records in one or both sets of graph data to obtain a representation of edit distance that is relative to the size of the corresponding data.

Finally, the comparison result, differences, and/or edit distance are outputted for use in verifying the first or second sets of graph data (operation 412). For example, the comparison result, differences, and/or edit distance may be included in a user interface, notification, alert, message, log file, document, report, database, and/or other form. In turn, users may analyze the comparison result, differences, and/or edit distance to validate the graph data and/or identify bugs or issues with replicating the graph data across multiple data sources and/or processing queries of the graph data.

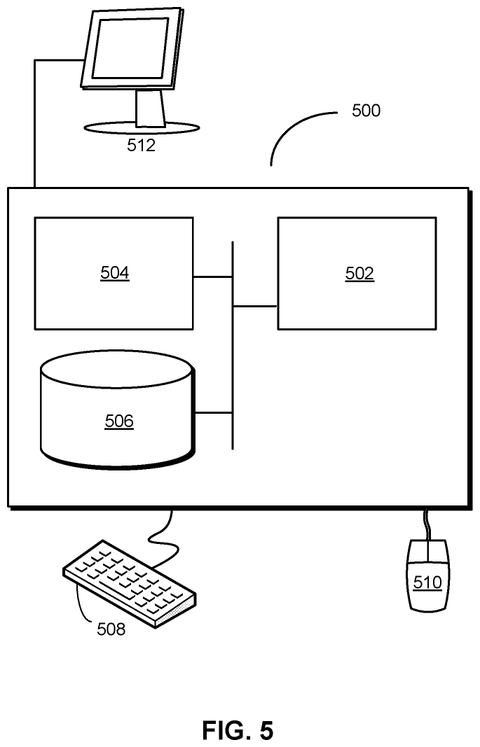

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing difference-based comparisons in log-structured graph databases. The system includes a comparison apparatus, which may alternatively be termed or implemented as a module, mechanism, or other type of system component. The comparison apparatus performs a first write of a first set of graph data to a first log-structured graph database followed by a second write of a second set of graph data to the first log-structured graph database to determine a first difference between the two sets of graph data. Next, the comparison apparatus performs a third write of the second set of graph data to a second log-structured graph database followed by a fourth write of the first set of graph data to the second log-structured graph database to determine a second difference between the two sets of graph data. The comparison apparatus then determines, based on the differences, a comparison result containing a set-based relationship between the two sets of graph data. Finally, the comparison apparatus outputs the comparison result for use in verifying one or both sets of graph data.

In addition, one or more components of computer system 500 may be remotely located and connected to the other components over a network. Portions of the present embodiments (e.g., comparison apparatus, graph database, source of truth, online network, etc.) may also be located on different nodes of a distributed system that implements the embodiments. For example, the present embodiments may be implemented using a cloud computing system that performs testing and/or verification of one or more remote graph databases and/or sources of graph data.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
performing, by one or more computer systems, a first write of a first set of graph data to a first log-structured graph database followed by a second write of a second set of graph data to the first log-structured graph database to determine a first difference between the first and second sets of graph data;
performing, by the one or more computer systems, a third write of the second set of graph data to a second log-structured graph database followed by a fourth write of the first set of graph data to the second log-structured graph database to determine a second difference between the first and second sets of graph data;
determining, based on the first and second differences, a comparison result comprising a set-based relationship between the first and second sets of graph data; and
outputting the comparison result for use in verifying the first or second sets of graph data.

2. The method of claim 1, further comprising:
including the first and second differences in the outputted comparison result.

3. The method of claim 1, further comprising:
combining the first and second differences into an edit distance between the first and second sets of graph data.

4. The method of claim 1, further comprising:
obtaining the first set of graph data in a first format and the second set of graph data in a second format prior to determining the first and second differences.

5. The method of claim 4, wherein the first and second formats comprise at least one of:
a graph log format; and
a serialization format.

6. The method of claim 1, wherein determining the first difference between the first and second sets of graph data comprises:
identifying a first offset representing a state of the first log-structured graph database after the first write is performed;
identifying a second offset representing a subsequent state of the first log-structured graph database after the second write is performed; and
determining the first difference as a change to the first log-structured graph database between the first offset and the second offset.

7. The method of claim 1, wherein determining the comparison result comprises:
determining that the first and second sets of graph data are identical when the first and second differences are empty.

8. The method of claim 1, wherein determining the comparison result comprises:
determining that the first set of graph data is a superset of the second set of graph data when the first difference is empty and the second difference is non-empty.

9. The method of claim 1, wherein determining the comparison result comprises:
determining that the second set of graph data is a superset of the first set of graph data when the first difference is non-empty and the second set difference is empty.

10. The method of claim 1, wherein determining the comparison result comprises:
determining that the first and second sets of graph data are not supersets of one another when the first and second differences are non-empty.

11. The method of claim 1, wherein performing the first and second writes to the first log-structured graph database comprises:
adding an entry from the first set of graph data to the first log-structured graph database during the first write; and
when the entry is found in the second set of graph data during the second write, omitting a duplicate addition of the entry to the first log-structured graph database.

12. The method of claim 1, wherein the first and second sets of graph data comprise:
a set of nodes;
a set of edges between pairs of nodes in the set of nodes; and
a set of predicates.

13. The method of claim 1, wherein the first and second sets of graph data are obtained from at least one of:
one or more versions of a log-structured graph database;
a source of truth for the log-structured graph database; and
an application-programming interface (API).

14. A system, comprising:
one or more processors; and
memory storing instructions that, when executed by the one or more processors, cause the system to:
perform a first write of a first set of graph data to a first log-structured graph database followed by a second write of a second set of graph data to the first log-structured graph database to determine a first difference between the first and second sets of graph data;
perform a third write of the second set of graph data to a second log-structured graph database followed by a fourth write of the first set of graph data to the second log-structured graph database to determine a second difference between the first and second sets of graph data;
determine, based on the first and second differences, a comparison result comprising a set-based relationship between the first and second sets of graph data; and
output the comparison result for use in verifying the first or second sets of graph data.

15. The system of claim 14, wherein the memory further stores instructions that, when executed by the one or more processors, cause the system to:
combine the first and second differences into an edit distance between the first and second sets of graph data.

16. The system of claim 14, wherein determining the first difference between the first and second sets of graph data comprises:
identifying a first offset representing a state of the first log-structured graph database after the first write is performed;
identifying a second offset representing a subsequent state of the first log-structured graph database after the second write is performed; and
determining the first difference as a change to the first log-structured graph database between the first offset and the second offset.

17. The system of claim 14, wherein determining the comparison result comprises:
determining that the first and second sets of graph data are identical when the first and second differences are empty;
determining that the first set of graph data is a superset of the second set of graph data when the first difference is empty and the second difference is non-empty;
determining that the second set of graph data is a superset of the first set of graph data when the first difference is non-empty and the second set difference is empty; and
determining that the first and second sets of graph data are not supersets of one another when the first and second differences are non-empty.

18. The system of claim 14, wherein performing the first and second writes to the first log-structured graph database comprises:
adding an entry from the first set of graph data to the first log-structured graph database during the first write; and
when the entry is found in the second set of graph data during the second write, omitting a duplicate addition of the entry to the first log-structured graph database.

19. The system of claim 14, wherein the first and second sets of graph data comprise:
a set of nodes;
a set of edges between pairs of nodes in the set of nodes; and
a set of predicates.

20. A non-transitory computer-readable storage medium storing instructions that when executed by a computer cause the computer to perform a method, the method comprising:
performing a first write of a first set of graph data to a first log-structured graph database followed by a second write of a second set of graph data to the first log-structured graph database to determine a first difference between the first and second sets of graph data;
performing a third write of the second set of graph data to a second log-structured graph database followed by a fourth write of the first set of graph data to the second log-structured graph database to determine a second difference between the first and second sets of graph data;
determining, based on the first and second differences, a comparison result comprising a set-based relationship between the first and second sets of graph data; and
outputting the comparison result for use in verifying the first or second sets of graph data.
